(19) United States
(12) Patent Application Publication
(10) Pub. No.: US 2014/0208265 A1
(43) Pub. Date: Jul. 24, 2014

(54) METHOD AND DEVICE FOR OPENING OBJECT AND STORAGE MEDIUM

(71) Applicant: TENCENT TECHNOLOGY (SHENZHEN) COMPANY LIMITED, Shenzhen (CN)

(72) Inventor: Heming SHAO, Shenzhen (CN)

(73) Assignee: TENCENT TECHNOLOGY (SHENZHEN) COMPANY LIMITED, Shenzhen (CN)

(21) Appl. No.: 14/219,343

(22) Filed: Mar. 19, 2014

Related U.S. Application Data
(63) Continuation of application No. PCT/CN2013/087848, filed on Nov. 26, 2013.

(30) Foreign Application Priority Data
Jan. 17, 2013 (CN) 201310017074.1

(51) Int. Cl. G06F 3/0481

(52) U.S. Cl. CPC G06F 3/0481
USPC 715/808

(57) ABSTRACT

The present invention relates to the field of computer technologies, and provides a method and a device for opening an object and a storage medium. The method for opening an object includes: monitoring an open instruction of the object; acquiring a recent use coefficient of the object if the open instruction is detected; and prompting the user to confirm the open instruction if the recent use coefficient meets a preset condition when compared with a preset threshold, and opening the object after receiving the confirmation on the open instruction from the user. With the present invention, different open processes are respectively performed according to the historical opening conditions of various objects, to effectively prevent the open of the object by a misoperation.

### CROSS-REFERENCE TO RELATED APPLICATION

This application claims priority to and is a continuation application of PCT/CN20131087848, filed on Nov. 26, 2013 and entitled “METHOD AND DEVICE FOR OPENING OBJECT AND STORAGE MEDIUM”, which claims the benefit of Chinese Patent Application No. 201310017074.1 filed on Jan. 17, 2013 by Tencent Technology (Shenzhen) Co., Ltd., titled “METHOD AND DEVICE FOR OPENING OBJECT”, which are incorporated herein by reference in their entirety.

### FIELD OF THE INVENTION

The present disclosure relates to the field of computer technologies, and in particular, to a method and a device for opening an object and a storage medium.

### BACKGROUND OF THE INVENTION

In most of the existing operating systems, objects such as applications and files are opened by single clicking with a mouse or a touch screen. However, considering the easy operation of the single click action, once a user accidentally touches a left key of the mouse or mistakenly chooses and clicks on an object not desired for opening, the system will consume system resources to open the object, and the user needs to take time to wait for the startup of the object, close the object afterwards, and then chooses another object for opening. Such misoperation increases operating actions of the user and wastes a lot of time costs. Especially for some objects that consume many system resources, such misoperation wastes more time costs of the user. Therefore, there is a need for a method for opening an object, which reduces the misoperations.

### SUMMARY OF THE INVENTION

Embodiments of the present disclosure provide a method and a device for opening an object and a storage medium, for solving the problem of a misoperation in opening an object with the existing method for opening an object, and such misoperation will increase the operating actions of the user and waste time of the user.

At an aspect, the present disclosure provides a method for opening an object, and the method includes:
monitoring an open instruction for opening an object;
acquiring a recent use coefficient of the object if the open instruction is detected; and
prompting a user to confirm the open instruction if the recent use coefficient meets a preset condition when compared with a preset threshold, and opening the object after receiving the confirmation on the open instruction from the user.

At another aspect, the present disclosure further provides a device for opening an object, comprising:
a monitoring unit configured for monitoring an open instruction for opening an object;
a use coefficient acquiring unit configured for acquiring a recent use coefficient of the object if the open instruction is detected; and
an opening unit configured for prompting the user to confirm the open instruction if the recent use coefficient meets a preset condition when compared with a preset threshold, and opening the object after receiving the confirmation on the open instruction from the user.

At yet another aspect, the present disclosure further provides a storage medium including computer-executable instructions, wherein the instructions are configured to perform a method for opening an object when executed by a computer processor, and the method includes:
monitoring an open instruction for opening an object;
acquiring a recent use coefficient of the object if an open instruction is detected; and
prompting a user to confirm the open instruction if the recent use coefficient meets a preset condition when compared with a preset threshold, and opening the object after receiving the confirmation on the open instruction from the user.

With the method for opening an object provided by the present disclosure, an open instruction for opening the object is monitored, a recent use coefficient of the object is acquired if the open instruction is detected, and the user is prompted to confirm the open instruction if the recent use coefficient meets a preset condition when compared with a preset threshold and the object is opened after receiving the confirmation on the open instruction from the user. With the present disclosure, different open processes are respectively performed according to the historical open situations of the various objects, to effectively prevent the opening of the object by a misoperation.

### BRIEF DESCRIPTION OF THE DRAWINGS

In order to more clearly illustrate the technical solutions of the embodiments of the disclosure, the drawings used for the description of the embodiments will be briefly introduced below. However, the drawings in the description below illustrate only some embodiments of the disclosure, and modifications and substitutions can be made to these drawings by those ordinary skilled in the art without creative work.

FIG. 1 is an implementing flow chart of a method for opening an object according to a first embodiment of the disclosure;

FIG. 2 is a schematic interface which prompts the user to confirm opening the object according to the first embodiment of the disclosure; and

FIG. 3 is a specific structural diagram of a device for opening an object according to a second embodiment of the disclosure.

### DETAILED DESCRIPTION OF THE EMBODIMENTS

To make the purposes, technical solutions and advantages of the disclosure more clear, the disclosure will be further illustrated below in conjunction with the drawings and specific embodiments in the specification. It should be understood that the specific embodiments described here are only used to explain the disclosure, rather than limiting the disclosure.

In the embodiments of the present disclosure, an open instruction for opening an object is monitored; and if the open instruction is detected, the recent use coefficient of the object is acquired; and if the recent use coefficient meets the preset condition when compared with the preset threshold, the user is prompted to confirm the open instruction, and the object is opened after the confirmation on the open instruction is received from the user.

The implement of the present disclosure will be detailedly described below in conjunction with the specific embodiments.

### First Embodiment

FIG. 1 shows an implementing flow chart of a method for opening an object according to the first embodiment of the disclosure, and the method includes Steps S101-S103 and is described below in detail.

At step S101, an open instruction for opening an object is monitored.

In the present embodiment, the object includes, but is not limited to an application and a file. The open instruction is used to invoke the corresponding system resources and processes to open an object corresponding to the open instruction, If the object is an application, the open instruction is a single click instruction, for example, and if the object is a file, the open instruction is a double click instruction, for example. Exemplarily, the open instruction for opening the object is monitored by an intelligent device in real time.

At step S102, if the open instruction is detected, a recent use coefficient of the object is acquired.

In the present embodiment, the recent use coefficient includes, but is not limited to any of a time difference and an open frequency. If the open instruction is detected, an intelligent device acquires the recent use coefficient of the object in the following manners 1 and 2.

Manner 1: if the open instruction is detected, the current time is recorded, and the time difference between the current time and the latest opening time when the object was opened is calculated.

Specifically, the current time is the current system time, the latest opening time is the time when the object was last opened in the system, and the time difference means the time elapsed between the current time and the latest opening time, If the open instruction is detected, the intelligent device records the current time and calculates the time difference between the current time and the latest opening time of the object.

Manner 2: if the open instruction is detected, an open frequency is calculated according to the historical opening times for opening the object during a preset time period.

Exemplarily, the preset time period is a fixed time period as preset in the system, within which the historical opening times of the object are counted. The preset time period is represented by a specific time period of a fixed duration starting from the current time. Preferably, the fixed duration is 30 days.

Exemplarily, the historical opening times are represented by the times for opening the object during the preset time period. If the open instruction is detected, the intelligent device calculates the open frequency according to the historical opening times for opening the object during the preset time period.

At step S103, if the recent use coefficient meets the preset condition when compared with the preset threshold, the user is prompted to confirm the open instruction, and the object is opened after the confirmation on the open instruction is received from the user.

In the present embodiment, the preset threshold is preset by the user and used for determining whether to open the object, and has a value which may he varied as desired. Exemplarily, the preset threshold includes a preset time difference threshold and/or a preset frequency threshold. Exemplarily, if the recent use coefficient is represented by the time difference and correspondingly the preset threshold is represented by a preset time difference threshold, the preset condition is that the time difference exceeds the preset time difference threshold. Exemplarily, if the recent use coefficient is represented by the open frequency and correspondingly the preset threshold is represented by a preset frequency threshold, the preset condition is that the open frequency is lower than the preset frequency threshold. If the time difference exceeds the preset time difference threshold, the user is prompted to confirm the open instruction, and the object is opened after the confirmation on the open instruction is received from the user; or else, if the open frequency is lower than the preset frequency threshold, the user is prompted to confirm the open instruction, and the object is opened after the confirmation on the open instruction is received from the user; or else, the object is directly opened.

If the recent use coefficient meets the preset condition when compared with the preset threshold, the user is prompted to confirm the open instruction, and the object is opened after the confirm on the open instruction is received from the user, specifically in the following two manners 1 and 2.

Manner 1: if the time difference exceeds the preset time difference threshold, the user is prompted to confirm the open instruction, and the object is opened after the confirmation on the open instruction is received from the user.

Manner 2: if the open frequency is lower than the preset frequency threshold, the user is prompted to confirm the open instruction, and the object is opened after the confirmation on the open instruction is received from the user.

Preferably, after opening the object, the intelligent device can further update the latest opening time of the object with the current time, and the historical opening times of the object is increased by 1.

Herein, an application of the present embodiment is described below in an example where an application on the desktop is taken as a specific target object.

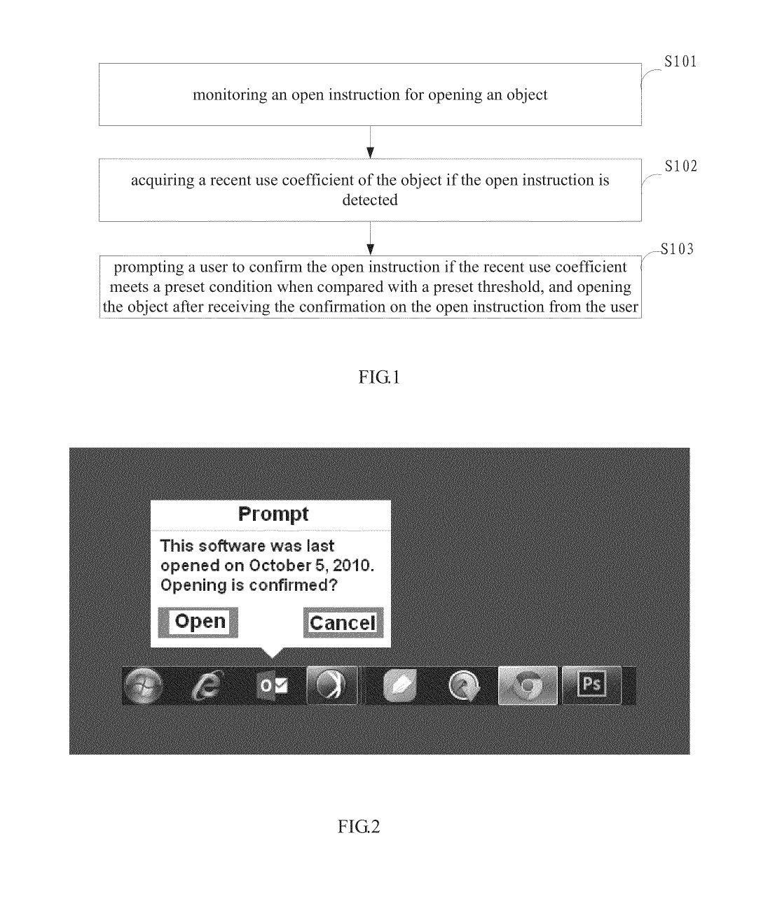

When the user clicks on an icon of an application, the current time is recorded and the time difference between the current time and the latest opening time of the application i.e. the target object) is calculated, and if the time difference between the latest opening time of the application and the current time exceeds the preset time difference threshold, a prompt box is popped up as shown in FIG. 2, to show the latest opening time of the application and meanwhile prompt the user to confirm the open instruction for opening the application; otherwise, if the time difference between the latest opening time of the application and the current time does not exceed the preset time difference threshold, that application is normally opened directly. If the confirmation on the open instruction is received from the user, the application is opened, the latest opening time of the application is updated with the current time, and the historical opening times is increased by 1; otherwise, the application is not opened.

In the present embodiment, different open processes are respectively performed according to a relationship between the recent use coefficient of the object and the preset threshold, to effectively prevent the open of the object by a misoperation and improve the user experience.

### Second Embodiment

The second embodiment of the present disclosure provides another specific application of the above method for opening an object as follows.

Herein, the application of the present embodiment is described below in an example where a file on the desktop is taken as a specific target object.

When the user clicks on an icon of a file, the historical opening times of the file within 30 days before the current time is counted to calculate the open frequency of the file, if the open frequency is lower than the preset frequency threshold, a prompting box is popped up to show the latest opening time of the file and prompt the user to confirm the open instruction for opening the file; and if the open frequency is higher than the preset frequency threshold, the file is normally opened directly. If the confirmation on the open instruction is received from the user, the file is opened, the latest opening time of the file is updated with the current time, and the historical opening times of the file is increased by 1; otherwise, the file is not opened.

### Third Embodiment

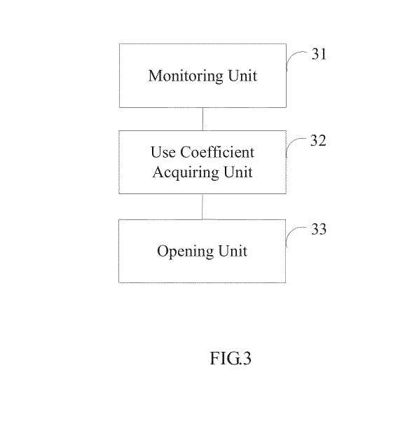

FIG. 3 shows the specific structural block diagram of a device for opening an object according to the third embodiment of the disclosure. For the sake of description, only portions relevant to the present embodiment of the present disclosure are shown. In the present embodiment, the device for opening an object includes a monitoring unit 31, a use coefficient acquiring unit 32, an opening unit 33, a determining unit and a coefficient updating unit.

The monitoring unit 31 is used to monitor an open instruction for opening an object.

The use coefficient acquiring unit 32 is used to acquire a recent use coefficient of the object if the open instruction is detected.

The opening unit 33 is used to prompt the user to confirm the open instruction if the recent use coefficient meets a preset condition when compared with the preset threshold, and open the object after receiving the confirmation on the open instruction from the user.

Furthermore, the recent use coefficient includes any of a time difference and an open frequency. The use coefficient acquiring unit 32 is specifically used to record the current time and calculate the time difference between the current time and the latest opening time of the object if the open instruction is detected; or else, the use coefficient acquiring unit 32 is specifically used to calculate an open frequency according to the historical opening times for opening the object during a preset time period if the open instruction is detected.

Furthermore, the opening unit 33 is used to prompt the user to confirm the open instruction if the time difference exceeds an preset time difference threshold, and open the object after receiving the confirmation on the open instruction from the user; or eke, the opening unit 33 is used to prompt the user to confirm the open instruction if the open frequency is lower than an preset frequency threshold, and open the object after receiving the confirmation on the open instruction from the user.

Furthermore, the device further includes a coefficient updating unit which is used to update the latest opening time of the object with the current time, and increase the historical opening times of the object by 1.

The device for opening an object provided by the embodiment of the present disclosure can embody the method as described in the above first embodiment, the reference may be made to the description of the above first embodiment for details, which are not further given hereinafter.

It should be noted that the various units included in the above embodiments are divided just according to the function and logic, but the disclosure is not limited this, as long as the corresponding functions can be implemented by the units. In addition, the specific name of each functional unit is just used for easy distinguishing from each other, rather than limiting the scope of the disclosure.

An embodiment of the present disclosure further provides a storage medium which includes computer-executable instructions, which, when executed by a computer processor, are configured to perform a method for opening an object, and the method includes: monitoring an open instruction for opening an object; acquiring a recent use coefficient of the object if the open instruction is detected; and prompting the user to confirm the open instruction if the recent use coefficient meets a preset condition when compared with a preset threshold, and opening the object after receiving the confirmation on the open instruction from the user.

Optionally, the recent use coefficient includes any of a time difference and an open frequency.

Acquiring the recent use coefficient of the object if the open instruction is detected includes: if the open instruction is detected, the current time is recorded, and the time difference between the current time and the latest opening time of the object is calculated; or else, if the open instruction is detected, an open frequency is calculated according to the historical opening times for opening the object during a preset time period.

Optionally, if the recent use coefficient meets the preset condition when compared with the preset threshold, prompting the user to confirm the open instruction and opening the object after receiving the confirmation on the open instruction from the user, includes: if the time difference exceeds the preset time difference threshold, the user is prompted to confirm the open instruction and the object is opened after the confirmation on the open instruction is received from the user; or else, if the open frequency is lower than the preset frequency threshold, the user is prompted to confirm the open instruction, and the object is opened after the confirmation on the open instruction is received from the user.

Optionally, the latest opening time of the object is updated with the current time, and meanwhile, the history opening times of the object is increased by 1.

In addition, a person skilled in the art can understand that the storage medium can be ROM RAM, disk, CD-ROM and so on.

The above description only illustrates some preferred embodiments of the invention, rather than limiting the scope of the invention. Various modifications, equivalent substitutions and improvements readily occurring to one skilled in the art without departing from the concept and principle of the invention all fall into the protection scope of the invention.

What is claimed is:

1. A method for opening an object, comprising:
monitoring an open instruction for opening an object;
acquiring a recent use coefficient of the object if the open instruction is detected; and
prompting a user to confirm the open instruction if the recent use coefficient meets a preset condition when compared with a preset threshold, and opening the object after receiving the confirmation on the open instruction from the user.

2. The method according to claim 1, wherein, the recent use coefficient comprises any of a time difference and an open frequency;
acquiring a recent use coefficient of the object if the open instruction is detected comprises:
recording the current time and calculating a time difference between the current time and the latest opening time of the object if the open instruction is detected; or
calculating an open frequency according to the historical opening times for opening the object during a preset time period if the open instruction is detected.

3. The method according to claim 2, wherein prompting a user to confirm the open instruction if the recent use coefficient meets a preset condition when compared with a preset threshold, and opening the object after receiving the confirmation on the open instruction from the user, comprises:
prompting the user to confirm the open instruction if the time difference exceeds the preset time difference threshold, and opening the object after receiving the confirmation on the open instruction from the user; or
prompting the user to confirm the open instruction if the open frequency is lower than the preset frequency threshold, and opening the object after receiving the confirmation on the open instruction from the user.

4. The method according to claim 2, after opening the object, further comprising:
updating the latest opening time of the object with the current time, and increasing the historical opening times for opening the object by 1.

5. The method according to claim 3, after opening the object, further comprising:
updating the latest opening time of the object with the current time, and increasing the historical opening times for opening the object by 1.

6. The method according to claim 1, wherein, the object comprises an application or a file.

7. The method according to claim 2, wherein, the object comprises an application or a file.

8. The method according to claim 3, wherein, the object comprises an application or a file.

9. The method according to claim 4, wherein, the object comprises an application or a file.

10. A device for opening an object, comprising:
a monitoring unit configured for monitoring an open instruction for opening an object;
a use coefficient acquiring unit configured for acquiring a recent use coefficient of the object if the open instruction is detected; and
an opening unit configured for prompting the user to confirm the open instruction if the recent use coefficient meets a preset condition when compared with a preset threshold, and opening the object after receiving the confirmation on the open instruction from the user.

11. The device according to claim 10, wherein, the recent use coefficient comprises any of a time difference and an open frequency;
the use coefficient acquiring unit is configured for recording the current time and calculating a time difference between the current time and the latest opening time of the object if the open instruction is detected; or configured for calculating an open frequency according to the historical opening times for opening the object during a preset time period if the open instruction is detected.

12. The device according to claim 11, wherein, the opening unit is configured for prompting the user to confirm the open instruction if the time difference exceeds a preset time difference threshold, and opening the object after receiving the confirmation on the open instruction from the user; or configured for prompting the user to confirm the open instruction if the open frequency is lower than a preset frequency threshold, and opening the object after receiving the confirmation on the open instruction from the user.

13. The device according to claim 12, further comprising:
an efficient updating unit which is configured for updating the latest opening time of the object with the current time, and increasing the historical opening times of the object by 1.

14. A storage medium comprising computer-executable instructions, wherein the instructions are configured to perform a method for opening an object when executed by a computer processor, and the method comprises:
monitoring an open instruction for opening an object;
acquiring a recent use coefficient of the object if the open instruction is detected; and
prompting a user to confirm the open instruction if the recent use coefficient meets a preset condition when compared with a preset threshold, and opening the object after receiving the confirmation on the open instruction from the user.

15. The storage medium according to claim 14, wherein,
the recent use coefficient comprises any of a time difference and an open frequency;
acquiring the recent use coefficient of the object if the open instruction is detected, comprises:
recording the current time and calculating a time difference between the current time and the latest opening time of the object if the open instruction is detected; or
calculating the open frequency according to the historical opening times for opening the object during a preset time period if the open instruction is detected

16. The storage medium according to claim 15, wherein, prompting a user to confirm the open instruction if the recent use coefficient meets a preset condition when compared with a preset threshold, and opening the object after receiving the confirmation on the open instruction from the user, comprises:
prompting the user to confirm the open instruction if the time difference exceeds a preset time difference threshold, and opening the object after receiving the confirmation on the open instruction from the user; or
prompting the user to confirm the open instruction if the open frequency is lower than a preset frequency threshold, and opening the object after receiving the confirmation on the open instruction from the user.

17. The storage medium according to claim 15, wherein, the latest opening time of the object is updated with the current time, and the historical opening times for opening the object is increased by 1.

18. The storage medium according to claim 16, wherein, the latest opening time of the object is updated with the current time, and the historical opening times for opening the object is increased by 1.
